(19) United States
(12) Patent Application Publication
(10) Pub. No.: US 2017/0312829 A1
(43) Pub. Date: Nov. 2, 2017

(54) MACHINE TOOL

(71) Applicant: O-M LTD., Osaka (JP)

(72) Inventors: Takio NAKAMURA, Nagaoka-shi (JP); Hirofumi NAKAKUBO, Nagaoka-shi (JP); Akihiro GOTO, Nagaoka-shi (JP); Kensaku SEKI, Nagaoka-shi (JP)

(73) Assignee: O-M LTD., Osaka (JP)

(21) Appl. No.: 15/497,551

(22) Filed: Apr. 26, 2017

(30) Foreign Application Priority Data
Apr. 27, 2016 (JP) 2016-089626

(51) Int. Cl. B23B 27/10; B23Q 11/10

(52) U.S. Cl. CPC B23B 27/10; B23Q 11/1038; B23B 2250/12

(57) ABSTRACT

A machine tool in which a fluid discharge port (4) for discharging a fluid (F) supplied from a fluid supply unit is provided to a rake surface (3) of a blade tip section (2) provided at a distal end section of the cutting tool (1), which cuts the workpiece (W), and the fluid (F) is discharged from the fluid discharge port (4) toward a rake-surface (2)-facing surface of chips (D) from the workpiece (W) that slide in pressure contact with the rake surface (3), the fluid (F) discharged from the fluid discharge port (4) reducing the force with which the chips (D) that slide in pressure contact with the rake surface (3) make pressure contact with the rake surface (3), and reducing the amount of frictional heat generated by the chips (D) sliding in pressure contact with the rake surface (3).

### BACKGROUND OF THE INVENTION

### 1. Field of the Invention

The present invention relates to a lathe, planer, or other machine tool that performs cutting work, and particularly relates to a machine tool having a function for suppressing the increase in temperature to high levels due to the frictional heat of a cutting tool during cutting work.

### 2. Description of the Related Art

In the past, when workpieces have been cut (lathed) using a lathe, planer, or other machine tool, chips that has been cut away from the workpiece slides in pressure contact with the rake surface of a blade tip section of a cutting tool to generate frictional heat. The frictional heat is conducted in distributed fashion to the cutting tool and the chips. The frictional heat conducted to the cutting tool brings the temperature to a high level the cutting tool and particularly the blade tip section to high temperature, and the blade tip section of the cutting tool is softened by the increase to temperatures of high levels. Abrasion is accelerated, and the service life of the cutting tool (blade tip section) is reduced.

Furthermore, when titanium, titanium alloy, nickel, nickel alloy, or another low heat-conducting material is used as the workpiece material as in recent years, the chips themselves also become a low heat-conducting material; the amount of heat conducted to the chips is thereby conducted to the cutting tool, and the amount of heat flowing into the cutting tool is increased four- to five-fold over prior-art levels. The more molten the blade tip section of the cutting tool becomes, the higher the temperature rises; abrasion of the blade tip section is even further accelerated, and the problem of reduced service life becomes even more pronounced.

Accordingly, in order to suppress such increases to temperatures of high levels in the blade tip section of the cutting tool during cutting work, machine tools that perform cutting work are provided with a blade tip section cooling mechanism for cooling the blade tip section during cutting work and suppressing increases to temperatures of high levels.

Conventionally, it has been common for the blade tip section cooling mechanism to be a wet type, in which coolant is introduced from a coolant supply unit provided in the vicinity of the blade tip section towards the blade tip section and the chips.

### SUMMARY OF THE INVENTION

However, current mechanisms for cooling a blade tip section do not directly cool the rake surface of the blade tip section of the cutting tool where frictional heat is generated, and as a result, cooling efficiency is low and the cutting tool (blade tip section) cannot be sufficiently suppressed from increasing to temperatures of high levels. Therefore, the problem of shortened service life of the blade tip section cannot be completely overcome.

With the aforedescribed current state of the art in view, it is an object of the present invention to provide an innovative machine tool that reduces, to the extent possible, frictional heat produced by a cutting tool during cutting work, and efficiently cools the cutting tool and make it possible to extend the service life of the cutting tool.

The main points of the present invention will be described with reference to the attached drawings.

A first aspect of the present invention relates to a machine tool for cutting and working a workpiece W using a cutting tool 1, wherein a fluid discharge port 4 for discharging a fluid F supplied from a fluid supply unit is provided to a rake surface 3 of a blade tip section 2 provided at a distal end section of the cutting tool 1, which cuts the workpiece W, and the fluid F is discharged from the fluid discharge port 4 toward a rake-surface 3-facing surface of chips D from the workpiece W that slide in pressure contact with the rake surface 3, the fluid F discharged from the fluid discharge port 4 reducing the force with which the chips D that slide in pressure contact with the rake surface 3 make pressure contact with the rake surface 3, and reducing the amount of frictional heat generated by the chips D sliding in pressure contact with the rake surface 3.

A second aspect of the present invention is the machine tool according to the first aspect, wherein when the distal end section of the blade tip section 2 cuts into the rotating workpiece W to cut and work the workpiece W, the chips D of the workpiece W are cut away so as to follow the rake surface 3 of the blade tip section 2 for cutting into the workpiece W, and the cut-away chips D slide in pressure contact with the rake surface 3, the fluid discharge port being provided to the rake surface 3 in the vicinity of the workpiece W, and being configured so that the fluid F is discharged at the base of the chips D cut away from the rotating workpiece W.

A third aspect of the present invention is the machine tool according to the first aspect, wherein the fluid supply unit is provided with a pumping device and is configured so that fluid F is pumped and supplied by the pumping device, the fluid F pumped and supplied from the fluid supply unit being discharged from the fluid discharge port 4 at a pressure capable of causing the chips D in pressure contact with the rake surface 3 to rise off from the rake surface 3, or at a pressure capable of severing the chips D in pressure contact with the rake surface 3.

A fourth aspect of the present invention is the machine tool according to the second aspect, wherein the fluid supply unit is provided with a pumping device and is configured so that fluid F is pumped and supplied by the pumping device, the fluid F pumped and supplied from the fluid supply unit being discharged from the fluid discharge port 4 at a pressure capable of causing the chips D in pressure contact with the rake surface 3 to rise off from the rake surface 3, or at a pressure capable of severing the chips D in pressure contact with the rake surface 3.

A fifth aspect of the present invention is the machine tool according to any of the first to fourth aspects, wherein the fluid F is a coolant F.

A sixth aspect of the present invention is the machine tool according to the fifth aspect, wherein the coolant F is strong alkali ion water F.

A seventh aspect of the present invention is the machine tool according to the fifth aspect, wherein the coolant F is intermixed with air.

An eighth aspect of the present invention is the machine tool according to the sixth aspect, wherein the coolant F is intermixed with air.

### Effects of the Invention

The amount of generated frictional heat produced in the blade tip section of a cutting tool is considerably reduced, and increases to temperatures of high levels in the blade tip section are dramatically suppressed, whereby softening produced by the increases to temperatures of high levels in the blade tip section are suppressed, and acceleration of abrasion of the blade tip section is suppressed. Accordingly, in the resulting machine tool, which has high industrial utility, the cutting tool and more particularly the blade tip section have a longer service life than in the prior art.

### BRIEF DESCRIPTION OF THE DRAWINGS

FIG. 1 is a perspective view illustrating the cutting tool of the present example;

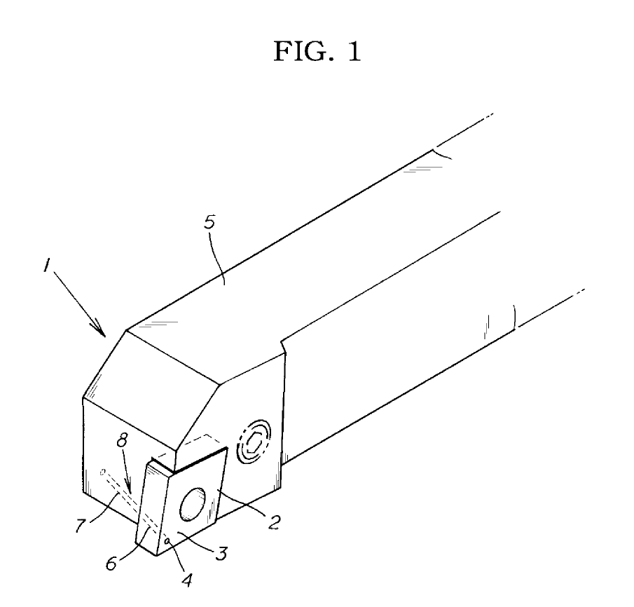

FIG. 2 is a perspective view illustrating during use of the present example;

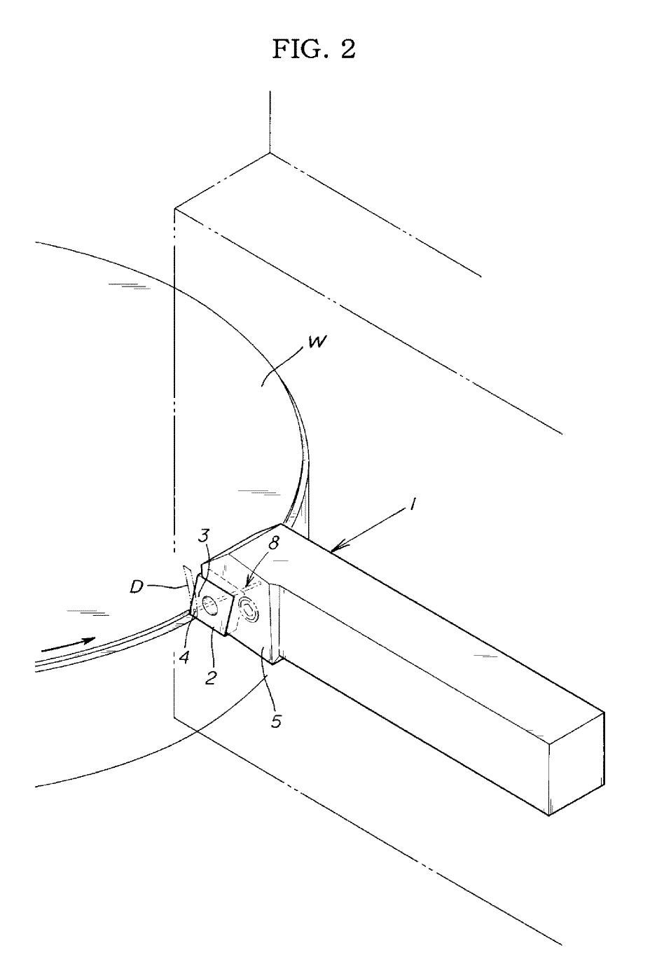

FIG. 3 is a schematic view illustrating the main points of FIG. 2; and

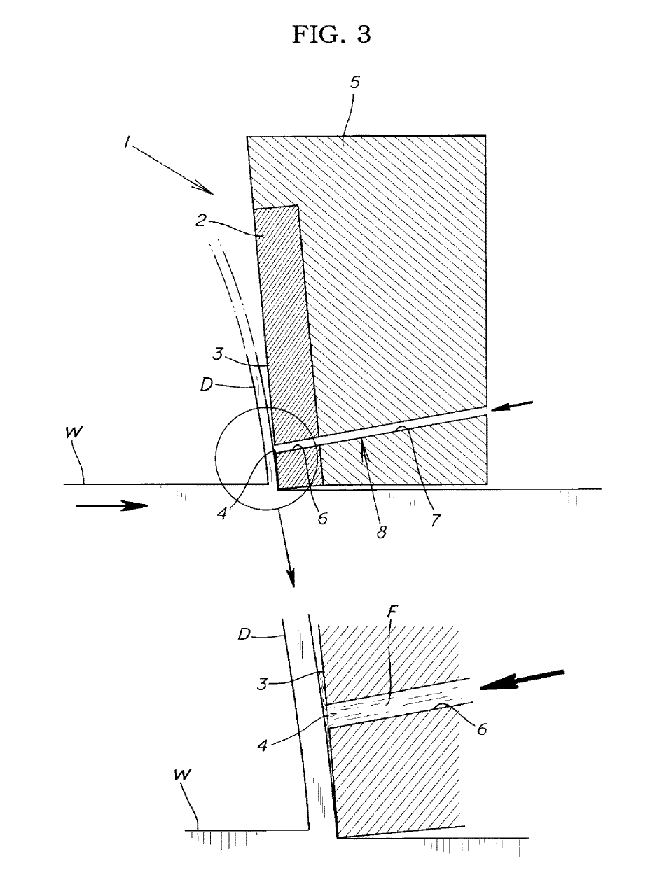

FIG. 4 is a table showing results of experimentation for confirming the effects of the present example.

### DESCRIPTION OF THE PREFERRED EMBODIMENTS

Preferred embodiments of the present invention will be described in brief illustrating the effects of the present invention with reference to the drawings.

During a cutting work, a fluid F supplied from a fluid supply unit is discharged between a rake surface 3 of a blade tip section 2 of a cutting tool 1 and chips D that have been cut away from the workpiece W by the cutting work and slide in pressure contact with the rake surface 3 of the blade tip section 2, the discharged fluid F, for example, is interposed between the rake surface 3 and the chips D and acts as a lubricant, the frictional force (frictional resistance) produced between the rake surface 3 and the chips D is reduced, and the amount of generated frictional heat is reduced.

Increases to temperatures of high levels as produced by the frictional heat in the blade tip section 2 of the cutting tool 1 are thereby suppressed, and softening of the blade tip section 2 is suppressed; therefore, acceleration of abrasion is suppressed and the service life of the cutting tool 1 (blade tip section 2) is extended.

Reducing the amount of frictional heat that is generated also reduces the amount of heat conducted to the workpiece W. Therefore, degradation of surface properties due to the increase in the temperature of the workpiece W to high levels is also suppressed, work precision is no longer adversely affected, and high-precision cutting work can be carried out.

For example, high-pressure fluid F is pumped and supplied from the fluid supply unit, and if the high-pressure fluid F is discharged from the fluid discharge port 4 at a pressure capable of causing the chips D that are in pressure contact with the rake surface 3 to rise away from the rake surface 3, or if the high-pressure fluid F is discharged from the fluid discharge port 4 at a pressure capable of severing the chips D that are in pressure contact with the rake surface 3, the high-pressure fluid F discharged from the fluid discharge port 4 causes the chips D in pressure contact with the rake surface to be lifted off (raised off), there ceases to be any pressure-contact sliding of the chips D on the rake surface 3 (pressure-contact sliding part) beyond at least the fluid discharge port 4; i.e., deeper than the fluid discharge port 4 of the pressure-contact sliding part in which the chips D slide in pressure contact with the rake surface 3, the amount of generated frictional heat produced by the chips D sliding in pressure contact with the rake surface 3 is reduced to the extent possible, increases to temperatures of high levels as produced by frictional heat of the blade tip section 2 of the cutting tool 1 are suppressed to a greater extent, and the service life of the cutting tool 1 (blade tip section 2) is prolonged to a greater extent.

Furthermore, using, e.g., a coolant F as the fluid F discharged from the fluid discharge port 4 causes the coolant F discharged from the fluid discharge port 4 to be vaporized by the frictional heat, a cooling effect on the blade tip section 2 is produced by the heat of vaporization, and increases to temperatures of high levels in the blade tip section 2 are suppressed, the blade tip section 2 is cooled and the increase in the temperature of the cutting tool 1 (blade tip section 2) to high levels is suppressed to a greater extent, and the service life of the cutting tool 1 is extended yet further.

### Example

A specific example of the present invention is described below with reference to the drawings.

The present example is a lathe-type machine tool for cutting and working a rotating workpiece W using a cutting tool 1 interchangeably mounted on a tool post, wherein a fluid discharge port 4 for discharging a fluid F supplied from a fluid supply unit is provided to a rake surface 3 of a blade tip section 2 provided at a distal end section of the cutting tool 1, which cuts the workpiece W, and the fluid F is discharged from the fluid discharge port 4 toward a rake-surface 3-facing surface of chips D from the workpiece W that slide in pressure contact with the rake surface 3, the fluid F discharged from the fluid discharge port 4 reducing the force with which the chips D that slide in pressure contact with the rake surface 3 make pressure contact with the rake surface 3, and reducing the amount of frictional heat generated by the chips D sliding in pressure contact with the rake surface 3. The machine tool is provided with a function for suppressing increases to temperatures of high levels in the blade tip section.

Specifically, as shown in the drawings, the cutting tool 1 of the present example comprises a blade tip section 2 and a shank section 5 provided with the blade tip section 2. A blade-tip-section-side flow channel 6 which communicates with the fluid discharge port 4 formed on the rake surface 3 is provided to the blade tip section 2. A shank-section-side flow channel 7 that communicates with the blade-tip-section-side flow channel 6 of the blade tip section 2 is provided to the shank section 5, and the fluid F supplied from the fluid supply unit is discharged from the fluid discharge port 4 provided to the rake surface 3 by way of a fluid introduction conduit 8 formed by the blade-tip-section-side flow channel 6 and the shank-section-side flow channel 7.

More specifically, a single fluid discharge port 4 is provided to the rake surface 3 of the blade tip section 2 with which the chips D cut away from the workpiece W slide in pressure contact when the distal end section of the blade tip section 2 cuts into the external peripheral surface of the rotating workpiece W and cuts and works the workpiece W, the single fluid discharge port 4 being provided in a position as near as possible to the workpiece W such that the durability of the blade tip section 2 is not reduced. In other words, a single fluid discharge port 4 is provided to the chip sliding route of the rake surface 3 on which the chips D slide in pressure contact, the single fluid discharge port 4 being provided in a position as near as possible to an advancement zone where the chips D advance onto the rake surface 3, and being configured so that the fluid F is discharged at the base of the chips D cut away from the rotating workpiece W. There is no limitation in regard to there being only one fluid discharge port 4 (no limitation in regard to the port being in a single location); a plurality thereof may be provided.

The fluid supply unit for supplying the fluid F to the cutting tool 1 configured in the manner described above is configured so as to supply coolant F having a cooling function, and is specifically configured so as to supply a water-soluble coolant F.

Pumping means (a pump) is provided to the fluid supply unit of the present example, and the above-described water-soluble coolant F is pumped and supplied to the cutting tool 1 side by the pumping means.

Specifically, when the water-soluble coolant F to be pumped and supplied is discharged from the fluid discharge port 4, the fluid supply unit pumps and supplies the water-soluble coolant F so as to be discharged at a high pressure of several megapascals to several tens of megapascals at which the chips D sliding in pressure contact with the rake surface 3 are caused to rise off the rake surface 3.

In other words, in the present example, the water-soluble coolant F is jetted during cutting work of the workpiece W at a high pressure of several megapascals to several tens of megapascals from the fluid discharge port 4 provided near the distal end section of the rake surface 3 of the blade tip section 2 of the cutting tool 1 toward the rake-surface 3-facing surface (the contact surface in contact with the rake surface 3) of the base portion of the chips D, which have been cut away from the workpiece W by the cutting work and which slide in pressure contact with the rake surface 3 of the blade tip section 2. The water-soluble coolant F jetted from the fluid discharge port 4 presses from the opposing surface side relative to the base portion of the chips D and causes the chips D to rise off from the vicinity of the base. The force with which the chips D make pressure contact with the rake surface 3 is reduced, the area over which the chips D contact the rake surface 3; i.e., the pressure-contact sliding area (pressure-contact sliding distance) is reduced, the amount of frictional heat generated by the chips D sliding in pressure contact with the rake surface 3 is suppressed, and increases to temperatures of high levels in the blade tip section 2 are suppressed.

Furthermore, the water-soluble coolant F has a lower coefficient of kinematic viscosity than an oil-based coolant and therefore exhibits a characteristic of exceptional cooling efficiency. In the present example, via this characteristic of the water-soluble coolant F, the chips D are caused to rise off by the water-soluble coolant F, whereby the water-soluble coolant F is supplied to a gap created between the chips D and the rake surface 3, and the water-soluble coolant F directly cools the rake surface 3. The blade tip section 2 (rake surface 3) is thereby efficiently cooled and increases to temperatures of high levels in the blade tip section 2 are suppressed.

The fluid F supplied from the fluid supply unit is not limited to being the water-soluble coolant F cited in the present example; e.g., air or an oil-based coolant may be used.

It is also possible to use strong alkali ion water, which has a greater cooling effect, as the water-soluble coolant F.

Air may be intermixed with the water-soluble coolant F or the above-noted strong alkali ion water F to further enhance the function of cooling the heat of vaporization and more efficiently cool the blade tip section 2.

In the present example, the chips D are caused to rise off by the discharge of the water-soluble coolant F from the fluid discharge port 4, but it is also possible to discharge (jet) the water-soluble coolant F discharged from the fluid discharge port 4 under higher pressure conditions. Severing the chips D makes it possible to prevent the incidence of faults caused by the chips D twining around the cutting tool 1 and the like.

Next, experiments were carried out to confirm the effect of suppressing increases to temperatures of high levels in the blade tip section in which increases to temperatures of high levels in the cutting tool 1 (blade tip section 2) are suppressed in the above-described cutting work of the present example. The experiment conditions and results will be discussed.

In this effect-confirming experiment, the temperature of the blade tip section 2 of the cutting tool 1 was measured for a case in which the cutting tool 1 was not cooled during cutting work (hereinafter referred to as dry scheme), a case in which the cutting tool 1 was cooled using a conventional cooling method (pouring a water-soluble coolant from the exterior) during cutting work (hereinafter referred to as conventional scheme), and a case in which the cutting tool 1 is cooled using the cooling method of the example during cutting work (hereinafter referred to as present example). The measurement results were compared and the effect of the present example in regard to suppressing increases to temperatures of high levels (i.e., the cooling effect) was confirmed.

In the present effect-confirming experiment, Inconel (specifically, Inconel 718), which is a material difficult to cut and in which frictional heat is readily generated during cutting, was used as the workpiece W for cutting work.

A cutting tool 1 having a blade tip section 2 comprising a super-hard alloy and a shank section 5 composed of chromium-molybdenum steel was used.

The cutting work was performed at depth t of 1.2 mm, a feed speed b of 0.1 mm/rev, and a cutting speed v of 56 m/min.

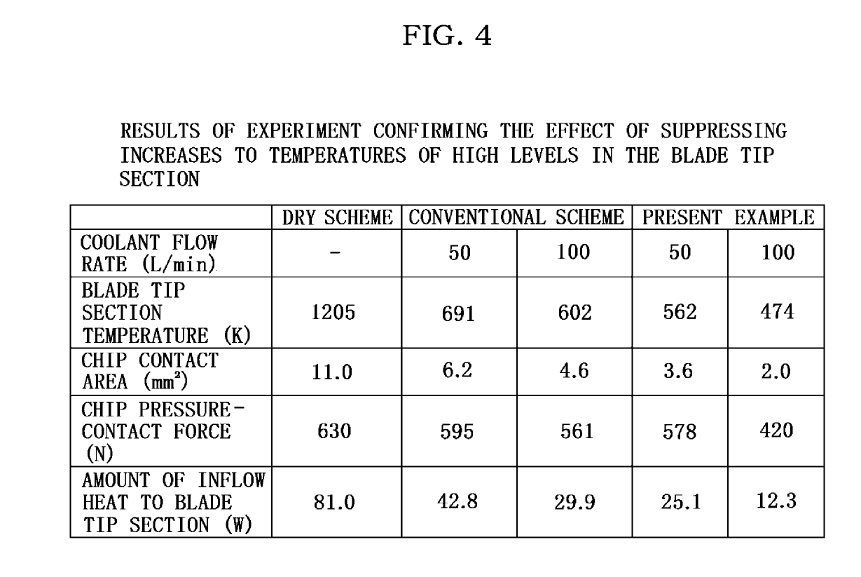

FIG. 4 shows the results of the present effect-confirming experiment performed under these conditions. As shown in FIG. 4, in the present example, in comparison with the comparative conditions (dry scheme, conventional scheme), the contact area (sliding pressure contact area) of the chips D in relation to the rake surface 3 is reduced, the pressure-contact force of the chips D against the rake surface 3 is reduced, and the amount of heat flowing into the blade tip section 2 is greatly reduced.

The temperature of the blade tip section 2 in the dry scheme was 1205 K (932° C.), and the temperature of the blade tip section 2 in the conventional scheme was 602 K (329° C.) to 691 K (418° C.), whereas the temperature of the blade tip section 2 in the present example was 474 K (201° C.) to 562 K (289° C.), confirming that the temperature is lower than the other schemes and that the increases to temperatures of high levels in the blade tip section 2 is suppressed.

Thus, the present example is an innovative machine tool in which the frictional heat produced in the cutting tool 1 (the rake surface 3 of the blade tip section 2) by the chips D during cutting work is reduced to the extent possible, the cutting tool 1 (blade tip section 2) having a temperature raised by the frictional heat is efficiently cooled, increases to temperatures of high levels in the cutting tool 1 (blade tip section 2) are suppressed, premature abrasion of the cutting tool 1 is prevented, and the service life of the cutting tool 1 and particularly the blade tip section 2 can be extended.

The present invention is not limited to the present example; the specific configuration of various structural features can be designed, as appropriate.

1. A machine tool for cutting and working a workpiece using a cutting tool, wherein a fluid discharge port for discharging a fluid supplied from a fluid supply unit is provided to a rake surface of a blade tip section provided at a distal end section of the cutting tool, which cuts the workpiece, and the fluid is discharged from the fluid discharge port toward a rake-surface-facing surface of chips from the workpiece that slide in pressure contact with the rake surface, the fluid discharged from the fluid discharge port reducing the force with which the chips that slide in pressure contact with the rake surface make pressure contact with the rake surface, and reducing the amount of frictional heat generated by the chips sliding in pressure contact with the rake surface.

2. The machine tool according to claim 1, wherein when the distal end section of the blade tip section cuts into the rotating workpiece to cut and work the workpiece, the chips of the workpiece are cut away so as to follow the rake surface of the blade tip section for cutting into the workpiece, and the cut-away chips slide in pressure contact with the rake surface, the fluid discharge port being provided to the rake surface in the vicinity of the workpiece, and being configured so that the fluid is discharged at the base of the chips cut away from the rotating workpiece.

3. The machine tool according to claim 1, wherein the fluid supply unit is provided with a pumping device and is configured so that fluid is pumped and supplied by the pumping device, the fluid pumped and supplied from the fluid supply unit being discharged from the fluid discharge port at a pressure capable of causing the chips in pressure contact with the rake surface to rise off from the rake surface, or at a pressure capable of severing the chips in pressure contact with the rake surface.

4. The machine tool according to claim 2, wherein the fluid supply unit is provided with a pumping device and is configured so that fluid is pumped and supplied by the pumping device, the fluid pumped and supplied from the fluid supply unit being discharged from the fluid discharge port at a pressure capable of causing the chips in pressure contact with the rake surface to rise off from the rake surface, or at a pressure capable of severing the chips in pressure contact with the rake surface.

5. The machine tool according to claim 1, wherein the fluid is a coolant.

6. The machine tool according to claim 5, wherein the coolant is strong alkali ion water.

7. The machine tool according to claim 5, wherein the coolant is intermixed with air.

8. The machine tool according to claim 6, wherein the coolant is intermixed with air.
